(19) United States
(12) Patent Application Publication
(10) Pub. No.: US 2009/0161891 A1
(43) Pub. Date: Jun. 25, 2009

(54) AUDIO SIGNAL HYBRID CONTROLLING DEVICE

(75) Inventors: Kun-Hong HOU, Taipei City (TW); Cheng-Lin CHEN, Taipei City (TW); Te-Hao LIU, Keelung City (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/123,684

(22) Filed: May 20, 2008

(30) Foreign Application Priority Data
Dec. 25, 2007 (TW) 096149876

(51) Int. Cl. H04Q 1/00

(52) U.S. Cl. 381/123

(57) ABSTRACT

An audio signal hybrid controlling device is provided. The audio signal hybrid controlling device is used for selecting an audio signal from a plurality of audio signals for an audio output device. The audio signal hybrid controlling device comprises: a USB input terminal for receiving a first audio signal; a portable music carrier receiving terminal for receiving a second audio signal; an audio signal output terminal for outputting an audio signal to the audio output device; and a switching unit for selecting one signal from the first and the second audio signals for the audio signal output terminal.

### BACKGROUND

The invention relates to an audio signal hybrid controlling device for selecting an audio signal from a plurality of audio signals for an audio output device.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

An iPod Docking device is an amplifier, which can be connected to a portable media carrier iPod and can amplify music output from the iPod. In addition, the iPod Docking comprises a USB connector for connecting with a personal computer. Accordingly, the iPod Docking device serves as a bridge connecting an iPod and a personal computer. Music data stored in the iPod can be accessed through a personal computer. In addition, an iPod can be charged through the USB connector of the iPod Docking device.

Referring to FIG. 1, FIG. 1 illustrates a schematic view of connection among an iPod, a personal computer, and an iPod Docking device. A system 1 comprises an iPod 11, an iPod Docking device 12 and a personal computer 13. The iPod Docking device 12 comprises a line-in terminal 121, connecting with the iPod 11, for receiving audio signals from the iPod. The audio signals are then amplified by the amplifier 122 of the iPod Docking device 12. The iPod Docking device 12 also comprises a first USB input terminal 123, connecting with the iPod 11, implementing data transmission with the iPod 11 and charging the iPod. The first USB input terminal 123 connects with a controlling unit 124 of the iPod Docking device 12. In addition, the controlling unit 124 connects with a second USB input terminal 125. The second USB input terminal 125 connects with the personal computer 13. The controlling unit 124 controls transmission between the personal computer 13 and the iPod 11, as well as the charge function.

Conventionally, the iPod Docking device cannot switch signal input between USB and line-in terminals. Accordingly, when an iPod Docking device is not connected with an iPod, the iPod Docking device cannot playback music data from a personal computer. In this circumstance, the iPod Docking device cannot serve as an amplifier of a personal computer. This causes limitations in application.

Accordingly, an iPod Docking device serving as an amplifier of an iPod and a personal computer is needed.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An audio signal hybrid controlling device is provided. The audio signal hybrid controlling device is used for selecting an audio signal from a plurality of audio signals for an audio output device. The audio signal hybrid controlling device comprises: a USB input terminal for receiving a first audio signal; a portable music carrier receiving terminal for receiving a second audio signal; an audio signal output terminal for outputting an audio signal to the audio output device; and a switching unit for selecting one signal from the first and the second audio signals for the audio signal output terminal.

### BRIEF DESCRIPTION OF DRAWINGS

The invention can be more fully understood by reading the subsequent detailed description and examples with references made to the accompanying drawings, wherein:

FIG. 1 illustrates a schematic view of connection among an iPod, a personal computer, and an iPod Docking device; and

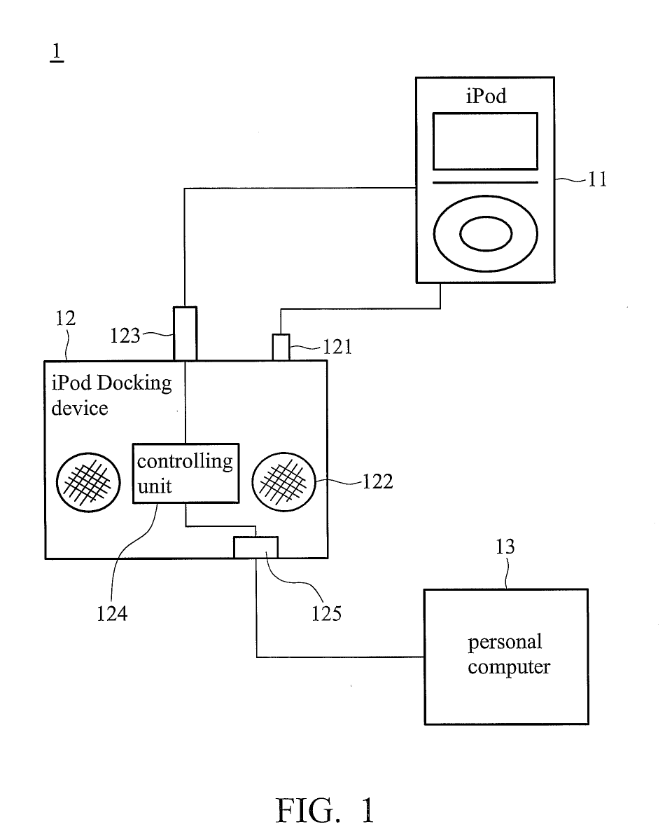

FIG. 2 illustrates a schematic view of an embodiment of an audio signal hybrid controlling device.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacturing for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

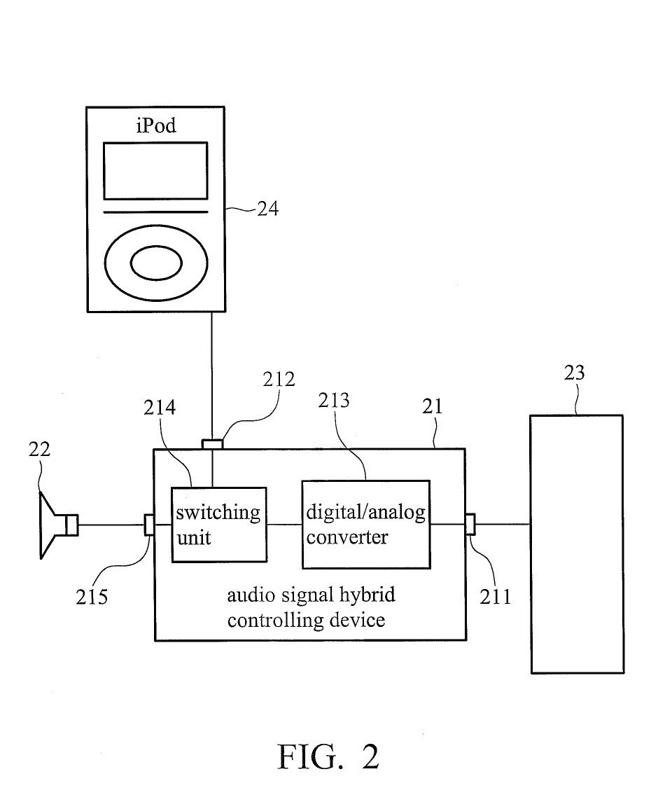

Referring to FIG. 2, FIG. 2 illustrates a schematic view of an embodiment of an audio signal hybrid controlling device. As shown in FIG. 2, audio signal hybrid controlling device 21 comprises a USB input terminal 211, a portable music carrier receiving terminal 212, a digital/analog converter 213, a switching unit 214, and an audio signal output terminal 215.

The USB input terminal 211 receives audio signals from a personal computer 23, and transmits the audio signals to the digital/analog converter 213, whereby the digital audio signals are converted to analogic audio signals. The audio signals are then transmitted to an output device 22, whereby output sound is generated by the output device 22 accordingly.

The portable music carrier receiving terminal 212 receives audio signals from the portable music carrier 24. The audio signals are then transmitted to the audio signal output terminal 215, and then transmitted from the audio signal output terminal 215 to the output device 22, whereby output sound is generated by the output device 22 accordingly.

The switching unit 214 connects with the digital/analog converter 213, the portable music carrier receiving terminal 212, and the signal output terminal 215, respectively. The switching unit 214 can be switched between two modes. According to one mode, the USB input terminal 211 is selected for receiving audio signals from the personal computer 23. Next, the audio signals are then transmitted to the digital/analog converter 213 connecting with the USB input terminal 211 for converting the digital audio signals to analogic audio signals. Following, the audio signals are then transmitted from the signal output terminal 215 to the output device 22, whereby output sound is generated by the output device 22 accordingly. In this mode, no audio signals are transmitted from the portable music carrier receiving terminal 212 to the audio signal output terminal 215.

According to the other mode, the portable music carrier receiving terminal 212 is selected for receiving audio signals from a portable music carrier. Next, the audio signals are then transmitted to the audio signal output terminal 215, and then transmitted from the audio signal output terminal 215 to the output device 22, whereby output sound is generated by the output device 22 accordingly. In this mode, no audio signals are transmitted from the USB input terminal 211 to the audio signal output terminal 215.

Accordingly, the switching unit 214 enables selection of audio signals from the portable music carrier receiving terminal 212 or the USB input terminal 211. The audio signals are transmitted to the audio signal output terminal 215, whereby output sound is generated by the output device 22 accordingly. By implementing the audio signal hybrid controlling device in iPod docking, a solution is provided for solving the problems of the conventional iPod docking system where the iPod docking device cannot serve as an amplifier of the iPod and the personal computer.

Here, the portable music carrier can be an iPod, which is capable of processing audio data in AAC format. It is to be understood that the invention is not limited to this embodiment. The invention can be implemented in any portable music carrier that can connect with the described system through an audio signal and data transmission modes.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An audio signal hybrid controlling device, selecting an audio signal from a plurality of audio signals for an audio output device, comprising:
a USB input terminal for receiving a first audio signal;
a portable music carrier receiving terminal for receiving a second audio signal;
an audio signal output terminal for outputting an audio signal to the audio output device; and
a switching unit coupled to the USB input terminal and the portable music carrier receiving terminal, for selecting and transmitting one of the first and the second audio signals to the audio signal output terminal.

2. The audio signal hybrid controlling device of claim 1, wherein the portable music carrier is capable of processing audio data in AAC format.

3. The audio signal hybrid controlling device of claim 1, wherein the first audio signal is a digital audio signal output from a personal computer.

4. The audio signal hybrid controlling device of claim 3, further comprising a digital/analog converter for converting the first audio signal to a first analogic audio signal.

5. The audio signal hybrid controlling device of claim 1, wherein the second audio signal is an analogic audio signal output from a portable music carrier.
